(19) United States
(12) Patent Application Publication
(10) Pub. No.: US 2010/0108863 A1
(43) Pub. Date: May 6, 2010

(54) LIGHT-SENSIBLE CONTROL DEVICE FOR LIGHT STRING

(76) Inventor: Chen-Sheng Yang, Kaohsiung (TW)

Correspondence Address: KOLISCH HARTWELL, P.C., 200 PACIFIC BUILDING, 520 SW YAMHILL STREET, PORTLAND, OR, 97204, US

(21) Appl. No.: 12/264,022

(22) Filed: Nov. 3, 2008

(51) Int. Cl. H01J 40/14

(52) U.S. Cl. 250/214 AL

(57) ABSTRACT

A light-sensible control device for a light string has a housing of transparent or translucent material, a control circuit board with a photo sensor mounted in the housing and two conductive plates protruding from the housing as a plug. The housing is pervious to light so that the photo sensor detects ambient light passing through the housing from different directions. Based on the detected intensity of the ambient light, the control device determines whether the light string should be turned on or turned off.

### BACKGROUND OF THE INVENTION

1. Field of the Invention

The invention relates to a light-sensible control device for a light string and more particularly to a control device with a wide light-sensing area to sense ambient light for controlling a light string.

2. Description of Related Art

With reference to FIG. 3, a convention control device (50) for a light string such as an LED light string, Christmas light string etc. is connected to a separate plug (60) through power wires (62) to receive an AC or DC voltage. The control device comprises an opaque box (51) defined with an opening, a control circuit board with a light sensor mounted in the opaque box, and a translucent housing (52) mounted on the opening and corresponding to the light sensor.

The control device (50) uses the light sensor to detect ambient light and determines whether the light string should be activated. When ambient light is bright enough and emits through the translucent housing (52), the control box (50) does not activate the light string. As the ambient light becomes dark, the control box (50) will automatically turn on the light string.

However, the control box (50) only has a small area, i.e. the translucent housing (52), to sense ambient light. In practical applications, the control box (50) is limited at a specific position and angle in such a way that the ambient light can directly transmit through the translucent housing (52). Therefore, even when the illumination surrounding the control box (50) is still bright, the light string may be unduly activated as the small translucent housing (52) is blocked.

To overcome the shortcomings, the present invention provides a light-sensible control box to mitigate or obviate the aforementioned problems.

### SUMMARY OF THE INVENTION

The main objective of the present invention is to provide a light-sensible control device with a large light-sensing area to detect ambient light for controlling a light string.

The light-sensible control device comprises a housing made of translucent or transparent material and allowing ambient light to pass through the housing from different directions, a control circuit board with a photo sensor to sense the ambient light securely mounted in the housing and two conductive plates protruding from the housing as a plug for receiving power and electronically connecting to the control circuit board.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a light-sensible control device for a light string in accordance with the present invention;

FIG. 2 is a control circuit diagram of the light-sensible control device of FIG. 1; and

FIG. 3 is a perspective view of a conventional control device for a light string.

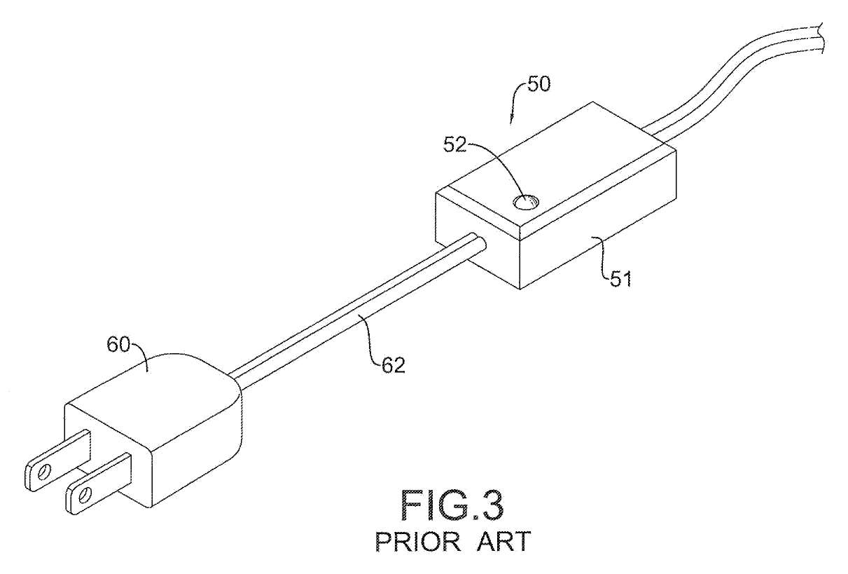

### DETAILED DESCRIPTION OF THE PREFERRED EMBODIMENT

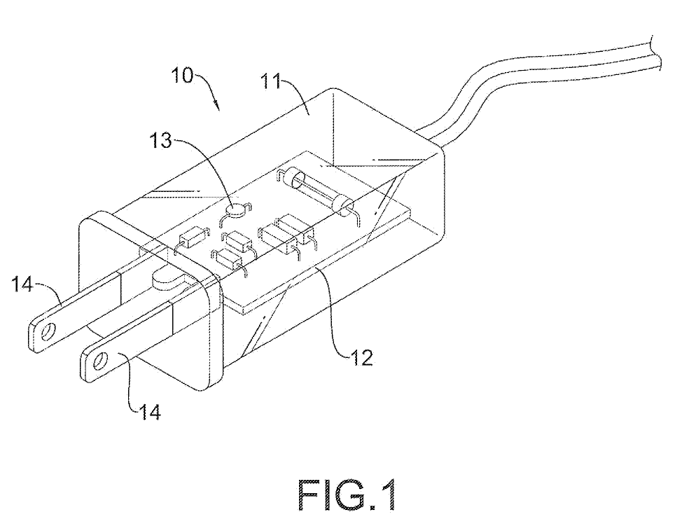

With reference to FIG. 1, a light-sensible control device (10) for a light string in accordance with the present invention comprises a housing (11), a control circuit board (12) and two conductive plates (14) as a plug.

The housing (11) is pervious to light, preferably made by transparent or translucent material so that ambient light surrounding the control device (10) can pass through the housing (11) in any directions.

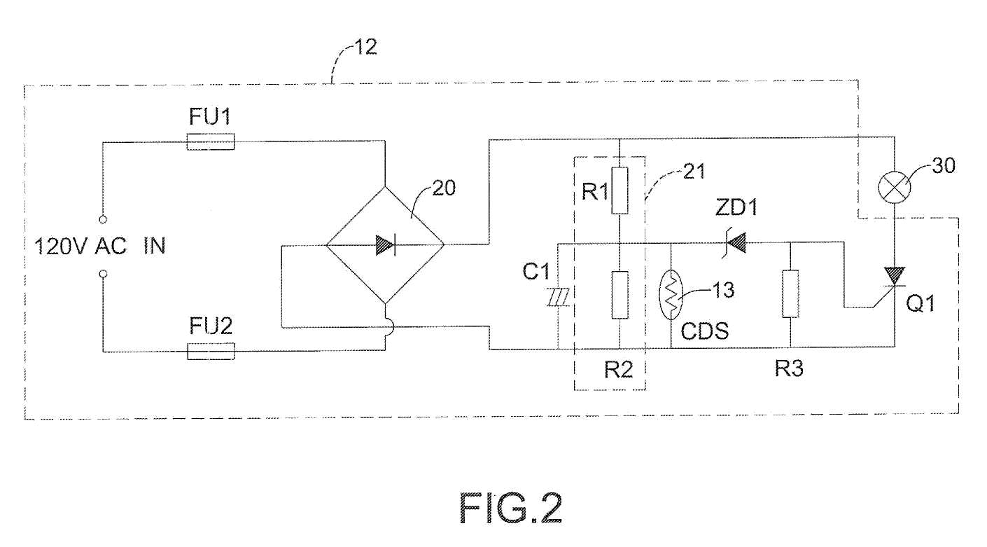

The control circuit board (12) is securely mounted in and enclosed by the housing (11). The control circuit board (12) has multiple electronic components such as fuses, resistors, capacitors, diodes etc. to construct a control circuit as shown on FIG. 2. The electronic components on the control circuit board (12) includes a photo sensor (13) to sense the ambient light around the control device (10).

The two conductive plates (14) protrude from the housing (11) as the plug and electronically connect to the control circuit board (12). The two conductive plates (14) is to be connected to a socket to receive AC or DC power. In this embodiment, the two conductive plates (14) receives the AC power and transmits the AC power to the control circuit.

With reference to FIG. 2, the control circuit includes a full bridge converter (20), a voltage divider (21), the photo sensor (13), a Zener diode (ZD1) and a switching component (Q1).

The full bridge converter (20) converts the AC power received from the conductive plates (14) to a DC power being output from two DC terminals. The voltage divider (21) has two resistors (R1, R2) and is connected between the DC terminals. The photo sensor (13) is connected in parallel to the resistor (R2). The switching component (Q1) is a silicon-controlled rectifier (SCR) with an anode, a cathode and a logic gate terminal. The cathode is connected to one of the DC terminals, for example the negative DC terminal. The logic gate terminal is connected to the photo sensor (13) through the Zener diode (ZD1).

A light string (30) to be controlled is connected between one of the DC terminals, such as the positive DC terminal, and the anode of the SCR.

As the ambient light gets dark, the resistance of the photo sensor (13) increases gradually. The high resistance of the photo sensor (13) eventually produces a voltage exceeding a certain threshold to trigger the logic gate terminal and turn on the SCR. Therefore, a drive current can flow through the light string (30) to activate all lighting units of the light string (30).

The light-sensible control device of the present invention allows a light sensor to receive and sense ambient light passing through a translucent or transparent housing from different directions. Therefore, the control device can adapt to much more different applications. Further, the two conductive plates are integrated to the control device as a plug to reduce the cost and simply the structure.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light-sensible control device for a light string, the control device comprising:
a housing made of translucent or transparent material and allowing ambient light to pass through the housing from different directions;
a control circuit board with a photo sensor to sense the ambient light securely mounted in the housing; and
two conductive plates protruding from the housing as a plug for receiving power and electronically connecting to the control circuit board.

2. The light-sensible control device as claimed in claim 1, wherein the plug receives AC power.

3. The light-sensible control device as claimed in claim 1, wherein the plug receives DC power.

4. The light-sensible control device as claimed in claim 2, wherein the control circuit board has a control circuit having:
a full bridge converter converting the AC power to a DC voltage being output from two DC terminals;
a voltage divider connected between the two DC terminals and having two resistors connected in series;
the photo sensor connected in parallel to one of the two resistors of the voltage divider;
a switching element connected to the photo sensor and to control the light string based on sense results of the photo sensor.
